(19) United States
(12) Patent Application Publication
(10) Pub. No.: US 2003/0040916 A1
(43) Pub. Date: Feb. 27, 2003

(54) Voice driven mouth animation system

(76) Inventor: Ronald Leslie Major, Greenside (ZA)

Correspondence Address: BURNS DOANE SWECKER & MATHIS L L P, POST OFFICE BOX 1404, ALEXANDRIA, VA, 22313-1404, US

(21) Appl. No.: 09/920,014

(22) Filed: Aug. 2, 2001

(51) Int. Cl. G10L 21/06; G10L 11/00

(52) U.S. Cl. 704/276

(57) ABSTRACT

An animation system includes a voice engine which processes audio input signals, typically speech signals, and converts them to a digital signal for processing. The digital signal is analysed to generate a value characteristic of each sample of the input signal and which is related to the maximum amplitude of the sample. The voice engine compares each value obtained in this way to the number of possible predetermined value ranges corresponding to a predetermined graphic showing a mouth position, and thus matches the input speech signal to a variety of possible mouth positions. The mouth graphics are superimposed on an image of a character substantially in real-time, providing an animated display of a character with its mouth synchronised to the input speech signal.

### BACKGROUND OF THE INVENTION

THIS invention relates to an animation system which is voice activated.

Conventional voice activated animation systems which generate animated graphics are complex and are mainly aimed at producing seamless, life-like animation. This, in turn, leads to difficulty in achieving proper live animation, with time aligning techniques being employed so as to align the speech signal and the animated sequence.

### SUMMARY OF THE INVENTION

According to the invention there is provided an animation system which is sound activated, the system comprising;

an input circuit for receiving an input sound signal;

a sampler for sampling the input sound signal;

a processor for generating a value characteristic of each sample;

a comparator for comparing each value to a plurality of pre-stored value ranges each corresponding to a predetermined graphic; and

a display Interface for displaying said predetermined graphics corresponding to each value sequentially;

wherein, for every sample of the input sound signal, the corresponding graphic is displayed substantially simultaneously therewith, so as to generate an animation sequence synchronised with the Input sound signal.

The input sound signal may be an analog signal and the sampler may comprise an analog to digital converter.

The processor is preferably arranged to generate a value characteristic of each sample by multiplying the sample by a window, performing a transform on the resultant signal to obtain a plurality of coefficients, and determining the maximum magnitude of the coefficients; the calculated value then being compared to the plurality of stored values.

In the preferred embodiment, the sample is a digitised signal which is multiplied by a Hamming window and the transform is a Fast Fourier Transform which generates a plurality of Fourier coefficients.

The predetermined graphic may be, for example, a mouth graphic representing a character's mouth.

In a preferred embodiment of the invention the display interface is arranged to display the predetermined graphics superimposed upon a display of an animated character or object.

Preferably, the display interface comprises a monitor on which a software generated display window is shown, the animated character and the predetermined graphics being displayed within the display window.

The predetermined graphics may be stored in a specified directory on a hard drive of a computer.

Preferably, a plurality of sets of predetermined graphics, each corresponding to a basic expression of an animated character, are stored in respective sub-directories.

The system may include a software based user interface for allowing the user to select a desired one of a plurality of character expressions, the system selecting the set of predetermined graphics corresponding to the selected expression.

In a preferred form of the invention, means for allowing the character to perform pre-determined actions or gestures is included.

The invention further allows the selection of a variety of camera shots, for example a close-up shot, a medium shot or any other kind of camera shot.

Advantageously, the invention includes means for controlling the speed at which the value characteristic of each sample is generated.

### BRIEF DESCRIPTION OF THE DRAWINGS

The invention will now be described in more detail, by way of example only, with reference to the accompanying drawings in which;

FIG. 1 is a schematic block diagram showing the major components of the live performance animation system according to the invention;

FIG. 2 is a schematic flow chart showing the method used in the voice engine component of the invention;

FIG. 3 is a graphical representation of the selection method used in determining which mouth position is to be displayed;

FIG. 4 shows the various mouth positions which may be displayed, as well as the associated letter or sounds;

FIG. 5 shows the character display window component of the invention;

FIG. 6 shows the user interface component of the invention;

FIG. 7 is a schematic flow chart showing the routine followed when the user interface component of the invention is initiated;

FIG. 8 is a schematic flow chart showing the relationship between the voice engine component and the user interface component; and

FIG. 9 is a schematic illustration of the directory arrangement employed by the invention.

### DESCRIPTION OF PREFERRED EMBODIMENTS

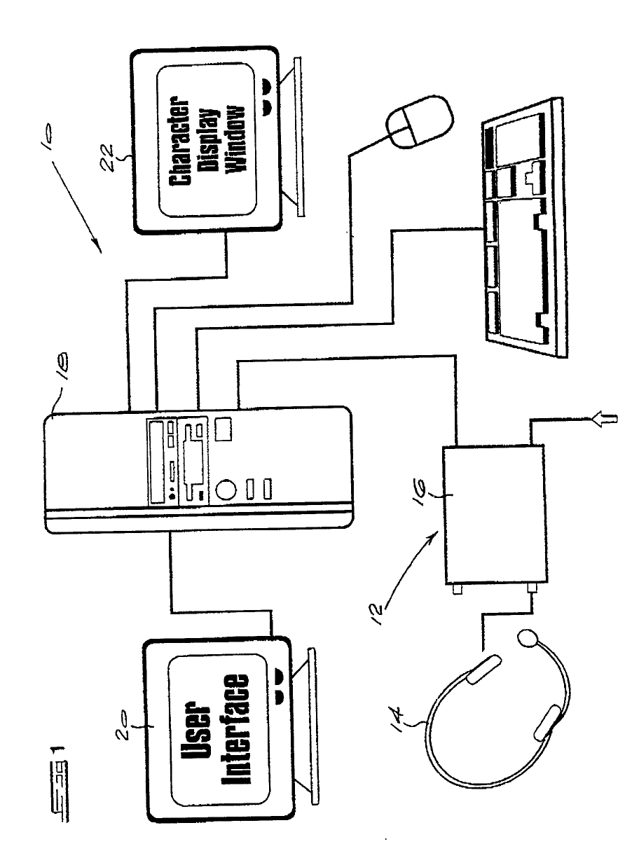

Referring to FIG. 1, a graphic animation system 10 of the invention comprises a voice engine 12 with a headset microphone 14 and an analogue to digital converter 16 which is connected to a processor 18. The system further comprises a user interface 20 as well as a character display interface using a monitor 22. These three components of the system operate together, as will be described further on in the specification.

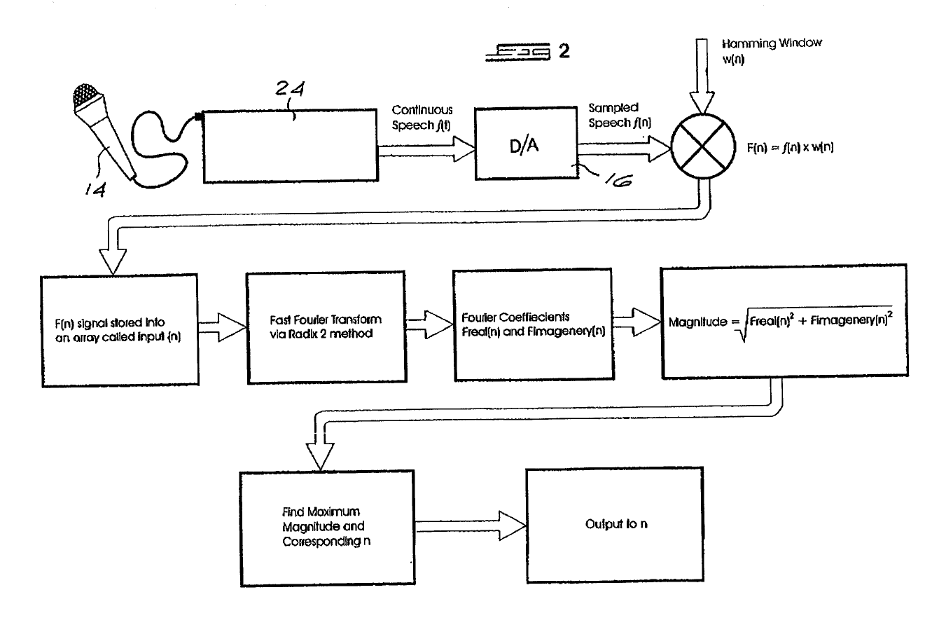

Referring now to FIG. 2, the voice engine is connected to the microphone 14 into which the user speaks, with the resulting continuous analogue speech signal from the microphone then being amplified by a pre-amplifier 24. The continuous speech signal f(t) is sampled by means of the analogue to digital converter 16, at a sampling rate of 16 kHz, resulting in a digital sampled speech signal f(n). The sampled speech signal f(n) is then multiplied by a Hamming window w(n) which is defined below, in which N is the number of samples and n is the sample number:

$$w ( n ) = 0.54 - 0.46 cos ( \frac{2 π n}{N - 1} ) for 0 \leq n \geq N - 1$$

The resulting weighted signal F(n) is stored in an array called input (n). A Discrete Fast Fourier Transform, achieved via the Radix-2 method, is then performed on the weighted signal F(n) resulting in an array of complex Fourier coefficients f(k).

The magnitude of each sample's complex coefficients is calculated using the following formula:

Magnitude (n)={square root over ((Fᵣₑₐₗ(n))²+(F_{imaginary}(n))²)}

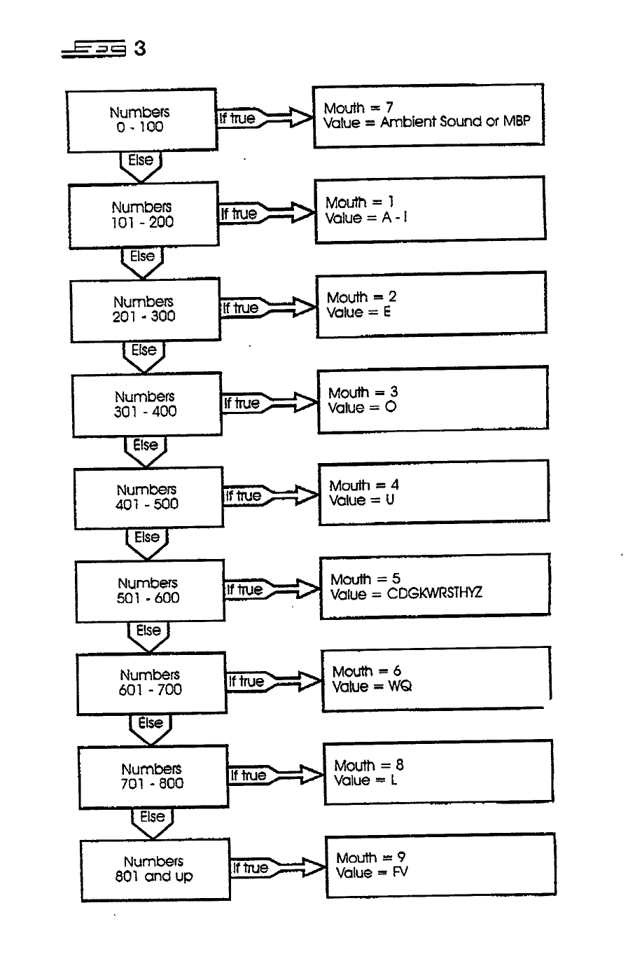

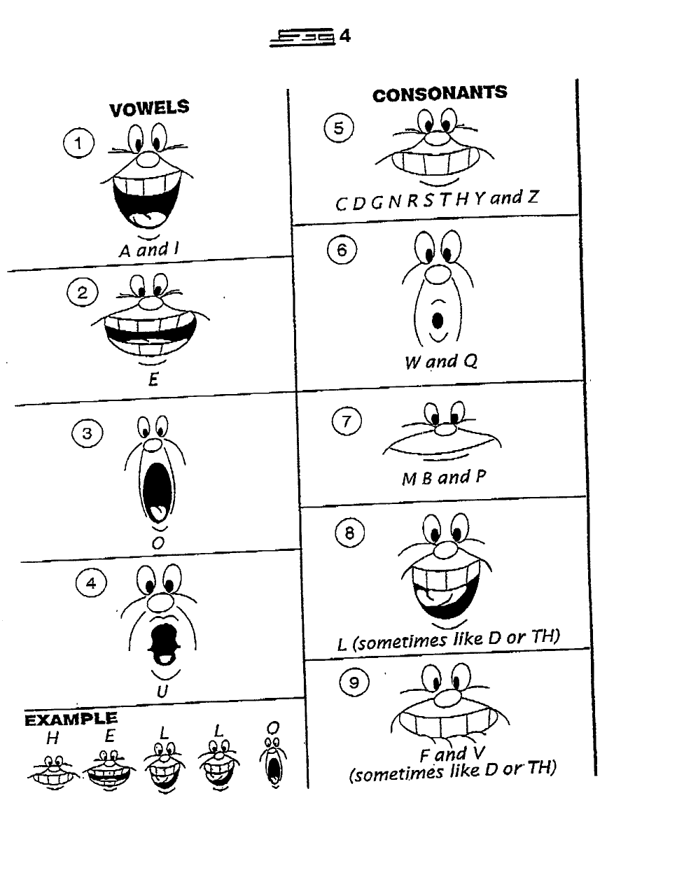

The maximum magnitude and corresponding sample number n are then found. This n is then compared to a stored set of previously derived ranges for n and the set that has the lowest comparative variance is then determined. This result governs which of a plurality of possible predetermined mouth positions corresponds to that particular sample of the incoming speech signal. The predetermined ranges for n and corresponding mouth values are shown in FIG. 3. The actual graphic mouth representations (mouth graphics) corresponding to the various mouth values are shown in FIG. 4, from which it may be seen that the user's speech pattern is broken up into nine possible mouth positions which are then displayed to give the illusion of animated speech. The result of this is that as the user speaks into the microphone, an animated character is able to mimic the user's speech with real time lip or mouth synchronisation by superimposing the resultant sequence of mouth graphics on a graphic representation of the character.

As an example, consider for N=512 the range of the vowel “A” is between 200 and 300. If the maximum magnitude of the coefficients is found to be at n=256 then the corresponding mouth position is “A”. The bitmap graphic file “02.bmp” is then loaded from the current directory and displayed in the character display window which is described below.

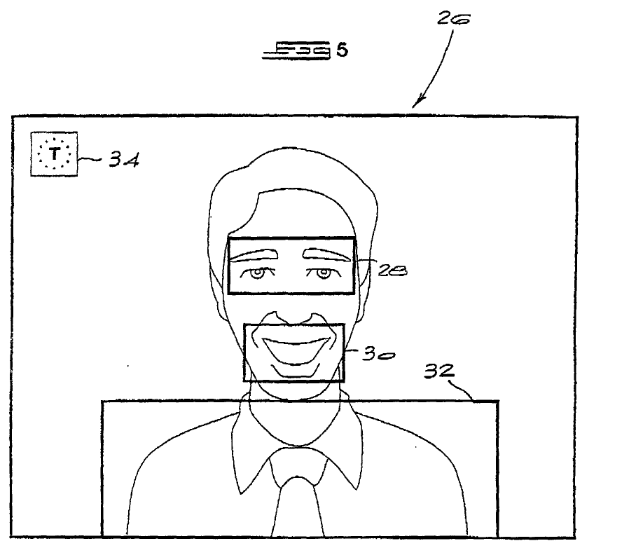

A typical character display window 26 appearing on the character display monitor 22 is shown in FIG. 5. Although the character shown in the display window 26 in FIG. 5 is a two-dimensional image of a person, it will be appreciated that the character can also be three-dimensional, with there being no limitation on the animation style or the design of the character used. It will also be appreciated that the “character” need not be a human or humanoid character at all, but could be any object which is made to “speak”.

The window 26 comprises an eye picture box 28, a mouth picture box 30 as well as a body picture box 32. The mouth picture box 30 displays the selected mouth position corresponding to the sample of the input speech signal, according to the output of the voice engine. The eye and body picture boxes 28, 30 display expressions and/or actions which the user has assigned to the character, as will be described further below with reference to the user interface. The character display window 26 further comprises a “blink timer” 34 which is a timer object which waits for three seconds and then triggers an event. On this trigger event, five bitmap files are displayed in the eye picture box 28, one after the other, to give the impression that the character is blinking

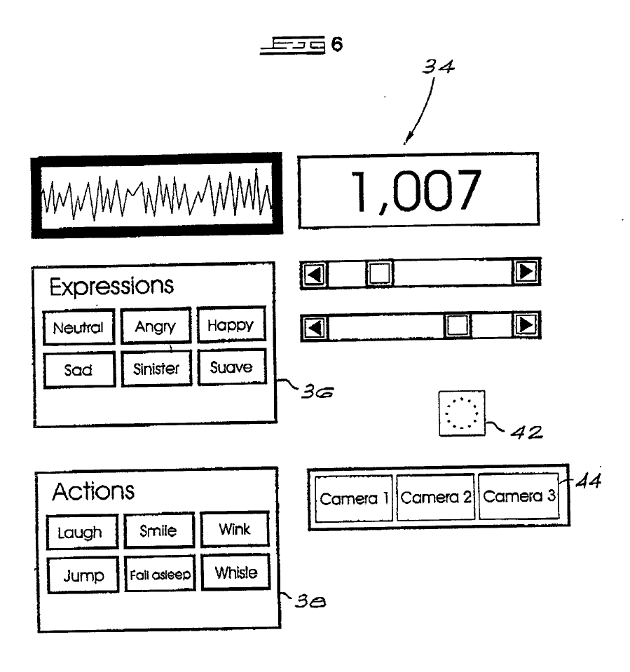

Referring now to FIG. 6, the user interface 34 of the invention allows the user to control the character. If the user wants to change the expression of the character, for example to neutral, happy, angry etc., he or she would click the relevant icon in the expressions box 36. The ability to change expressions is made possible in that for each expression there are provided all nine frames needed for the different mouth positions, adapted for the different expressions. These sets of frames are each stored in a separate directory, and when the user clicks on one of the expression buttons, the software changes to the corresponding directory and loads the nine new images needed.

Similarly, if the user wants the character to perform one of the pre-animated sequences of actions, he or she would click the relevant icon on the actions box 38. All images are stored in either Windows Bitmap (BMP), Compuserve Gif (GIF), Joint Picture Experts Group (JPG) or Windows Metafile (WMF) format, which are decoded by appropriate decompression routines within the software. When the user clicks any one of the keys in the actions box 38, the character's eye picture box 28 and mouth picture box 30 are displayed over the appropriate image file of the body for the action being played. Once the action is completed, the characters eye, mouth and body picture boxes are redisplayed.

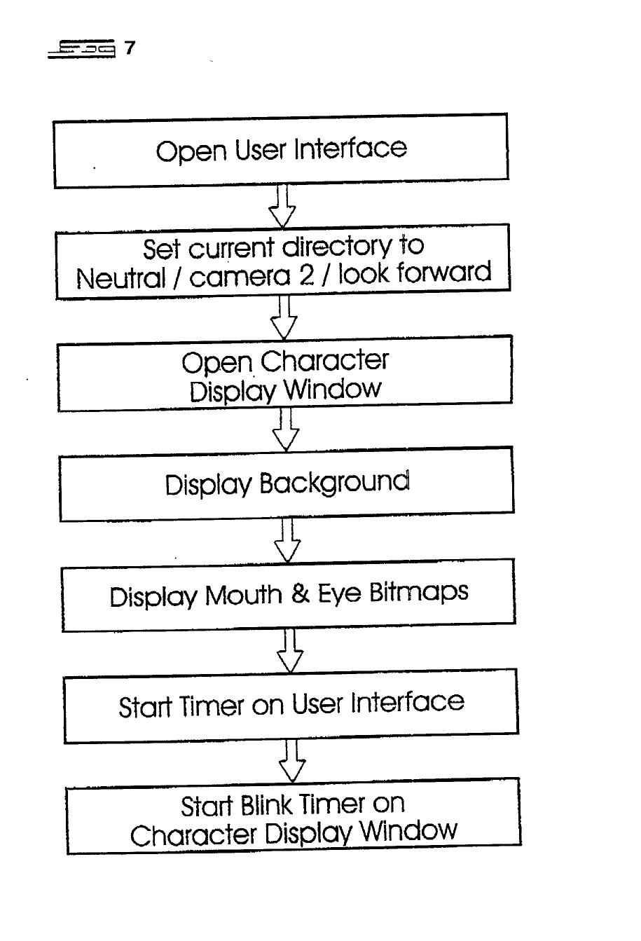

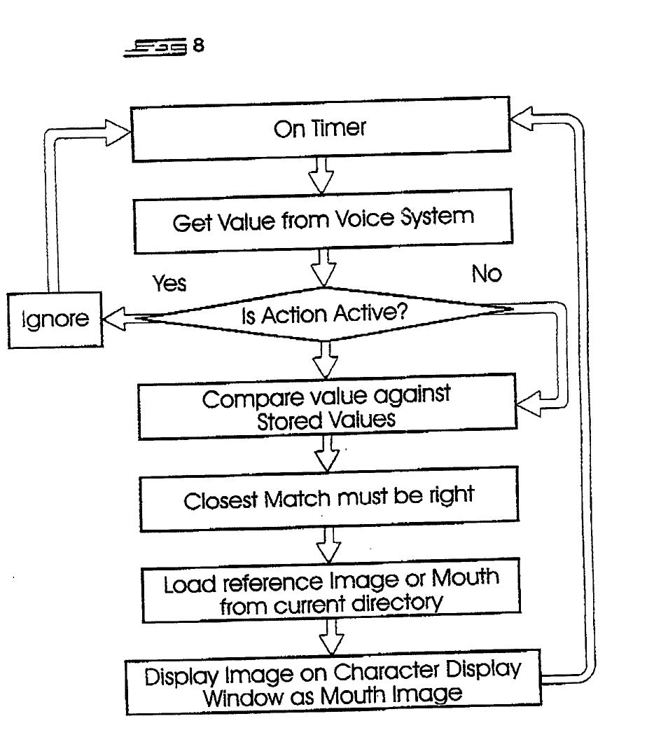

With reference to FIG. 7, when the user interface 34 component is initialised, the system reverts to all of the default settings, and the character display window 26 is opened. The user interface 34 includes a timer 42 which runs continuously and processes the incoming value from the voice engine as is shown in FIG. 8. As is clear from FIG. 8, the system first checks to see if any actions are currently running. If the result is “NO” then the application takes the value obtained by the voice engine and compares it to the set of stored values, as described earlier. Based upon the result of this comparison, the relevant mouth graphic bitmap file is loaded and displayed in the mouth picture box 30 of the character display window 26. If, on the other hand, the result of the check in FIG. 8 is “YES” which means that an action is currently playing, no further processing takes place.

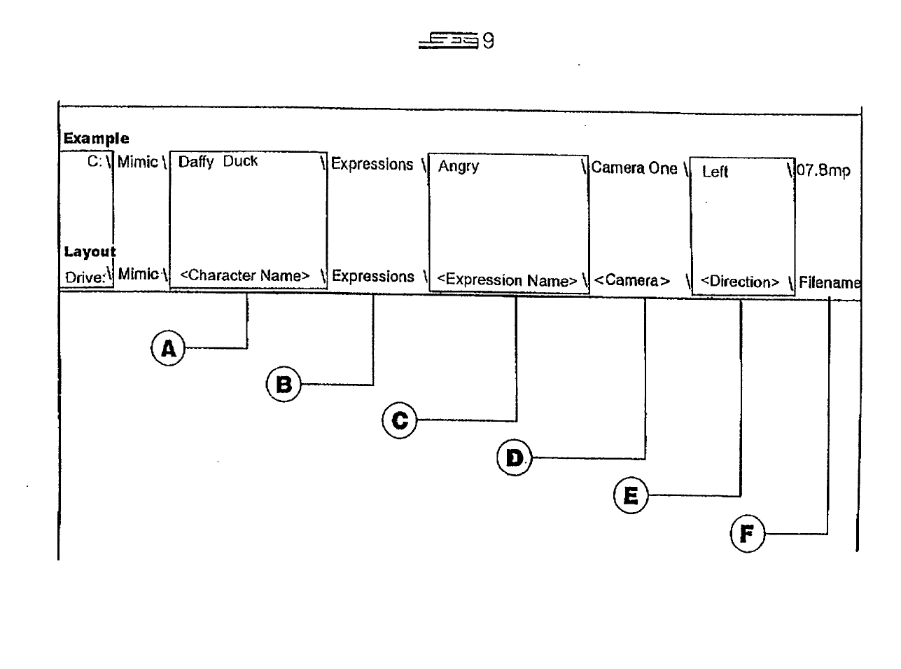

Since the graphic bitmap files are relatively small, they load and display relatively quickly giving the illusion of real time animation. The rapid change of expressions is achieved by exploiting the character's directory structure on the drive, which is shown in FIG. 9. The drive includes a character's base directory having an expressions sub-directory on level B. Within this sub-directory, further sub-directories on level C are provided for each possible expression. The invention further provides for three different camera positions on level D, typically a close up, a medium shot and a long shot. A further sub-directory on level E is created which contains the direction in which the character is looking. A further sub-directory on level F contains the actual bitmap files representing each mouth position.

For example, if the user wants to change the expression of the character he or she would click the required expression icon on FIG. 6. The application would then change directory at level C on FIG. 8. Similarly, if the user were to change the current camera view, the directory that would change would be on level D of FIG. 9 and, once changed, all of the picture boxes on the character display window 26 would be reloaded.

The system includes a speech speed control, shown in FIG. 6, which is in the form of a horizontal slider with a range of 1 to 100. The setting of this slider will decide the speed at which the voice engine value is interpreted. If the speed is increased from say 10 to 30, the timer object's value would change, which would have the visual effect that the character's speech would be slower, and vice versa. This value may thus be adjusted to present a particular artistic style.

The dominant feature of the present invention is thus its unique ability to convert human speech Into graphically represented character speech in real-time or near real-time. It further allows the user the opportunity of manipulating the character in order to obtain the desired animation.

The invention is thus a real time animation system which is positioned between conventional animation software and motion capture. As has been described, the invention allows a single user to control an animated character in real time by speaking into a microphone and triggering gestures and actions on the fly. Thus, there is no need to synchronise the voice signal manually to the generated image since, because of the method used by the invention, it could be said that the audio signal is automatically synchronised with the visual images.

The main advantage of the invention is that the animated character mimics the operator with real time lip synch which is voice driven. Since the system is mainly software based, no motion capture devices are required, which greatly simplifies implementation of the present invention. Furthermore, there are no limitations in the character that is to be used, and the character may thus be any two-dimensional or a three-dimensional image, including human or non-human characters or objects.

I claim:

1. An animation system which is sound activated, the system comprising:
an input circuit for receiving an input sound signal;
a sampler for sampling the input sound signal;
a processor for generating a value characteristic of each sample;
a comparator for comparing each value to a plurality of pre-stored value ranges each corresponding to a predetermined graphic; and
a display interface for displaying said predetermined graphics corresponding to each value sequentially;
wherein, for every sample of the input sound signal, the corresponding graphic is displayed substantially simultaneously therewith, so as to generate an animation sequence synchronised with the input sound signal.

2. An animation system according to claim 1 wherein the input sound signal is an analog signal and the sampler comprises an analog to digital converter.

3. An animation system according to claim 1 wherein the processor is arranged to generate a value characteristic of each sample by multiplying the sample by a window, performing a transform on the resultant signal to obtain a plurality of coefficients, and determining the maximum magnitude of the coefficients; the calculated value then being compared to the plurality of stored values.

4. An animation system according to claim 3 wherein the sample is a digitised signal which is multiplied by a Hamming window and wherein the transform is a Fast Fourier Transform which generates a plurality of Fourier coefficients.

5. An animation system according to claim 1 wherein the predetermined graphic is a mouth graphic representing a character's mouth.

6. An animation system according to claim 5 wherein the display interface is arranged to display the predetermined graphics superimposed upon a display of an animated character or object.

7. An animation system according to claim 6 wherein the display interface comprises a monitor on which a software generated display window is shown, the animated character and the predetermined graphics being displayed within the display window.

8. An animation system according to claim 1 wherein the predetermined graphics are stored in a specified directory on a hard drive of a computer.

9. An animation system according to claim 8 wherein a plurality of sets of predetermined graphics, each corresponding to a basic expression of an animated character, are stored in respective sub-directories.

10. An animation system according to claim 9 including a software based user interface for allowing the user to select a desired one of a plurality of character expressions, the system selecting the set of predetermined graphics corresponding to the selected expression.
